(19) United States
(12) Patent Application Publication
(10) Pub. No.: US 2013/0064528 A1
(43) Pub. Date: Mar. 14, 2013

(54) HEATING COVER FOR A DEVICE FOR TRANSPORTING A FLUID CONTAINING A HYDROCARBON

(71) Applicants: Thibaud Bigex, Pau (FR); Jérôme Woirin, Pau (FR)

(72) Inventors: Thibaud Bigex, Pau (FR); Jérôme Woirin, Pau (FR)

(73) Assignee: TOTAL SA, Courevoie (FR)

(21) Appl. No.: 13/641,344

(22) PCT Filed: Mar. 22, 2011
(86) PCT No.: PCT/FR11/50603

§ 371 Date: Nov. 26, 2012

(30) Foreign Application Priority Data
Apr. 14, 2010 (FR) 1052844

(51) Int. Cl. F16L 53/00

(52) U.S. Cl. 392/468

(57) ABSTRACT

The invention relates to a heating cover for a device for transporting a fluid containing a hydrocarbon. The heating cover includes a first electrical insulation layer, a heating layer arranged on the first electrical insulation layer comprising carbon fibres embedded in an elastomer, a second electrical insulation layer arranged on the heating layer, a heat insulation layer arranged on the second electrical insulation layer, and power supply means.

### PRIORITY CLAIM

The present application is a National Phase entry of PCT Application No. PCT/FR2011/050603, filed Mar. 22, 2011, which claims priority from French Application No. 1052844, filed Apr. 14, 2010, the disclosures of which are hereby incorporated by reference herein in their entirety.

### FIELD OF THE INVENTION

This invention relates to a heating cover for a device for transporting a fluid containing a hydrocarbon.

### BACKGROUND OF THE INVENTION

Devices for transporting hydrocarbons are sometimes installed in very cold environments on land and at sea, sometimes at very great depths underwater. Under such conditions, the fluid may freeze or congeal or paraffin formation may occur. These fluid reactions can cause plugging and interfere with fluid transport in a transportation device such as a pipeline, a line, or a valve. That is why such hydrocarbon fluid transportation devices are sometimes heated to prevent these problems.

Heating covers exist for hydrocarbon pipelines or lines. They are usually wound around the line, and several straps hold it against the line. Document US 2006/102615 describes such a heating cover.

However, such covers are relatively ineffective, they wear out, and they comprise heating elements in the form of conductive copper lines that break relatively easily when the heating cover is handled. The object of this invention is to perfect such covers.

### SUMMARY OF THE INVENTION

A heating cover for a device for transporting a fluid containing a hydrocarbon according to one embodiment of the invention extends over a surface and comprises a first face intended to be substantially in contact with the transportation device and a second face opposite the first face, said heating cover comprising in a direction transverse to the surface, from the first face:
a first electrical insulation layer,
a heating layer on the first electrical insulation layer, said heating layer comprising carbon fibers embedded in an elastomer,
a second electrical insulation layer on the heating layer, said first and second electrical insulation layers covering the heating layer to electrically insulate said heating layer,
a heat insulation layer on the second electrical insulation layer, suitable for thermally insulating the second electrical insulation layer, and
electrical power supply means intended to bring an electrical current to said heating layer, said electrical current flowing in said heating layer in order to heat said heating layer.

With these arrangements, the heating cover heats more effectively and more evenly.

Furthermore, the heating cover is more flexible, less subject to wear, and localized damage does not stop the electrical conduction and heating of the cover, so that such a heating cover is more able to withstand any incident.

In various embodiments of the heating cover according to the invention, one or more of the following arrangements may optionally be used:
the heat insulation layer comprises a membrane forming a fluid-tight pouch with an internal cavity in said pouch, said internal cavity being filled with a heat insulation fluid;
the heat insulation fluid is a viscous gel;
the first and second electrical insulation layers comprise fiberglass or Kevlar fibers embedded in an elastomer;
the first and second electrical insulation layers and the heating layer comprise the same elastomer;
the elastomer is a silicone;
the cover further comprises:
   a first coating layer under the electrical insulation layer, and
   a second coating layer between the second electrical insulation layer and the heat insulation layer, said first and second coating layers covering said electrical insulations layers in order to be fluid-tight;
the first and second coating layers comprise an elastomer, and preferably a silicone;
the first and second coating layers have a thickness greater than 0.5 mm, and preferably greater than 2 mm;
the cover further comprises magnetic elements enabling the heating cover to be attracted by the transportation device by magnetic attraction;
the magnetic elements are magnetic particles measuring less than 0.2 mm embedded in the elastomer;
the magnetic particles are composed of a material selected from among ferrite, neodymium iron boron, alnico, and samarium cobalt;
the surface comprises at least:
   a central portion intended to come over an upper part of the transportation device, and
   flap portions around the central portion, the flap portions being intended to substantially come over a side part of the transportation device and come together laterally two by two in order to substantially enclose said transportation device.

### BRIEF DESCRIPTION OF THE DRAWINGS

Other features and advantages of this invention will become apparent from the following description of two of its embodiments, given as non-limiting examples, with reference to the attached drawings.

In the drawings:

FIG. 1 is a cross-sectional view of a first embodiment of the heating cover,

FIG. 2 is a perspective view of a heating cover having a first form,

FIG. 3 is a cross-sectional view showing a first use of the heating cover, said use possibly corresponding to the heating cover from FIG. 2,

FIG. 4 is a perspective view of a heating cover having a second form,

FIG. 5 is a perspective view showing a second use of the heating cover, said use possibly corresponding to the heating cover from FIG. 4,

FIG. 6 is a cross-sectional view of a second embodiment of the heating cover.

In the various figures, the same references designate identical or similar elements.

### DETAILED DESCRIPTION OF THE DRAWINGS

The longitudinal direction mentioned in this description should be understood as the direction going in the direction X designated on the figures. A transverse direction mentioned in this description should be understood as the direction Y or Z designated on the figures. These directions are mentioned only to assist with reading and understanding the invention. The illustrated surface S extends in a plane XY, for simplicity of illustration, but that surface may extend in any direction. Furthermore, it may not be a plane.

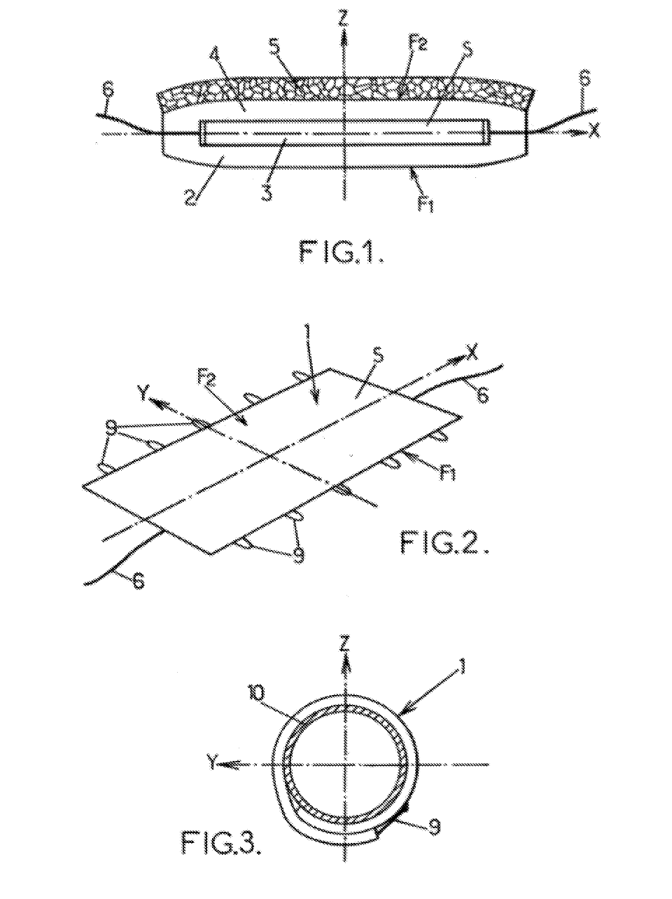

FIG. 1 is a transverse cross-sectional view of a first embodiment of a heating cover 1 for a device for transporting a fluid containing a hydrocarbon such as crude oil, gas, heavy oil, or the like.

That heating cover extends over a surface S, shown in FIG. 2 in a plane XY. The heating cover comprises a first face F1, which can be referred to as the “lower face,” and a second face F2 opposite the first face, said second face F2 possibly being referred to as the “upper face.”

In the cross-section shown in FIG. 1, in a transverse direction to the surface S (direction Z here) from the first face F1 and in the direction of the second face F2, the heating cover comprises:
a first electrical insulation layer 2,
a heating layer 3 on the first electrical insulation layer 2,
a second electrical insulation layer 4 on the heating layer 3,
a heat insulation layer 5 on the second electrical insulation layer 4, and
electrical power supply means 6 for the heating layer 3.
The heating layer 3 is composed of carbon fibers embedded in an elastomer. The carbon fibers may be unidirectional, for example all aligned in the direction X, or multidirectional. Alternatively, the carbon fibers are arranged in a woven fabric, the fabric having carbon fibers in two directions or carbon fibers in a first direction and other fibers in a second direction.

The elastomer holds the fibers and provides a sufficiently elastic heating layer so that the heating cover is flexible. That elastomer will advantageously be a silicone.

The carbon fibers are electrically conductive and capable of heating by the Joule effect, i.e., due to the electrical resistance of the carbon fibers, when an electric current flows through them.

The electrical resistance R of such a heating layer 3 between the first and second ends (1a, 1b) of the line can be approximated with the following formula:

$$R = {ρ}_{fibre} \cdot \frac{{L}_{3}}{{S}_{3}}$$

where:
ρ_{fibre} is a resistivity of the carbon fibers, having for example ρ_{fibre}=1,9.10⁻⁵ Ω·m as a value at a temperature of 20° C., which is substantially 1100 times more resistive than copper at 20° C.,
L₃ is a length of the heating layer 3 in the longitudinal direction X,
S₃ is a transverse cross-section of the heating layer 3, with S₃=Lₜ·Eₚ,
Eₚ is a thickness of the heating layer in a transverse direction, such as the direction Z, and

Lₜ is a width of the heating layer in another transverse direction, such as the direction Y.

The electrical power P consumed to heat the transportation device 10 is equal to P=V²/R, where V is a voltage supplied to said heating layer 3.

The size of the heating layer 3 is a function of the electrical power required. For example, it may have a thickness of between 0.5 mm and 20 mm, and preferably between 1 mm and 10 mm, and for example 5 mm.

The first and second electrical insulation layers 2, 4 completely cover the heating layer 3, so that the heating layer 3 is located inside these electrical insulation layers. The heating layer 3 is thus properly electrically insulated from the external environment.

The electrical insulation layers 2, 4 are composed of an elastomer, and advantageously of a silicone.

As a variant, these electrical insulation layers 2, 4 also comprise fiberglass or Kevlar fibers, such that the electrical insulation of these layers is improved.

The first and second electrical insulation layers 2, 4 and the heating layer 3 may have the same elastomer, which simplifies the manufacturing process for those layers and promotes adhesion among them so that they form a single continuous piece.

Furthermore, due to the elastomer in these layers of the heating cover 1, it is flexible and easily implemented to maximize the contact surface with the transportation device in order to heat it effectively.

The sizes of the first and second electrical insulation layers 2, 4 are a function of the electrical insulation required, i.e., the power supply voltage V. For example, they may have a thickness of between 0.1 mm and 10 mm, and preferably between 1 mm and 5 mm.

The heat insulation layer 5 is suitable for thermally insulating the second electrical insulation layer 4. This heat insulation layer 5 thermally insulates the second face F2 of the heating cover 1. The heat generated by the heating cover 3 is not lost by that second face F2. It is concentrated toward the first electrical insulation layer 2 and the first face F1 of the heating cover 1 in contact with the device for transporting a hydrocarbon fluid. More generally, the heat insulation layer 5 thermally insulates the heating cover 1 from the external environment. The heating cover 1 is thus effective for heating the transportation device.

In a first variant, the heat insulation layer 5 comprises at least one polyurethane (PU) material.

In a second variant, the heat insulation layer 5 comprises a membrane forming a fluid-tight pouch with an internal cavity that is closed, said pouch having at least one face in contact with the second electrical insulation layer 5 of the heating cover 1 such that said second electrical insulation layer 4 is thermally insulated from the external environment.

In addition, the internal cavity is filled with a heat insulation fluid. The heat insulation fluid is a highly thermally insulating material, such as a viscous gel.

With this variant, the heat insulation layer is very efficient and very flexible, so that the heating cover 1 is also efficient and very flexible and is easy to use on the transportation device.

The electrical power supply means 6 make it possible to bring an electric current from outside the heating cover 1 to the heating layer 3. When that electric current flows through the heating layer, the layer is heated. The heat generated is transmitted by conduction to the transportation device by the contact with the first face F1 of the heating cover 1.

As shown in FIG. 1, the electrical power supply means 6 may comprise two power supply cables, each cable being connected to one end of the heating layer 3 in the longitudinal direction X, for example, by a connection transverse to that longitudinal direction X, so as to be electrically connected to a large number of carbon fiber ends in said heating layer 3. These carbon fibers are then supplied power in parallel through said end connections. The heating layer 3 is supplied power by the two cables carrying the voltage V.

The surface S of the heating cover 1 may have numerous forms, each being substantially suitable for the application of said heating cover.

In a first variant form of the surface S of the heating cover 1 shown in FIG. 2, it extends in a surface S that is substantially rectangular. On two edges of said heating cover 1, it may have, for example, attachment means 9 suitable for securing said edges to each other, or to other attachment means mounted on the surface of the heating cover 1 or on the transportation device 10 to be heated.

Such a heating cover 1 may then be used as shown in the transverse cross-section in FIG. 3, where the hydrocarbon transportation device 10 is a substantially cylindrical pipe or pipeline, and the heating cover 1 is wound around said pipe with the first electrical insulation layer 2 or the first face F1 in contact with said pipe 10, and the heat insulation layer 5 or the second face F2 radially outward relative to the pipe 10, in order to concentrate and conserve the heat generated by the heating cover toward the pipe 10. Furthermore, the winding of the heating cover 1 may have an overlap area in order to keep heat losses to a minimum.

With this first form, the transportation device 10 is wrapped in the heating cover 1. It is heated by the heating cover 1 and the disadvantages due to cold mentioned in the introduction are avoided or resolved. The heating cover 1 can subsequently be left on the line or removed for reuse elsewhere or later on.

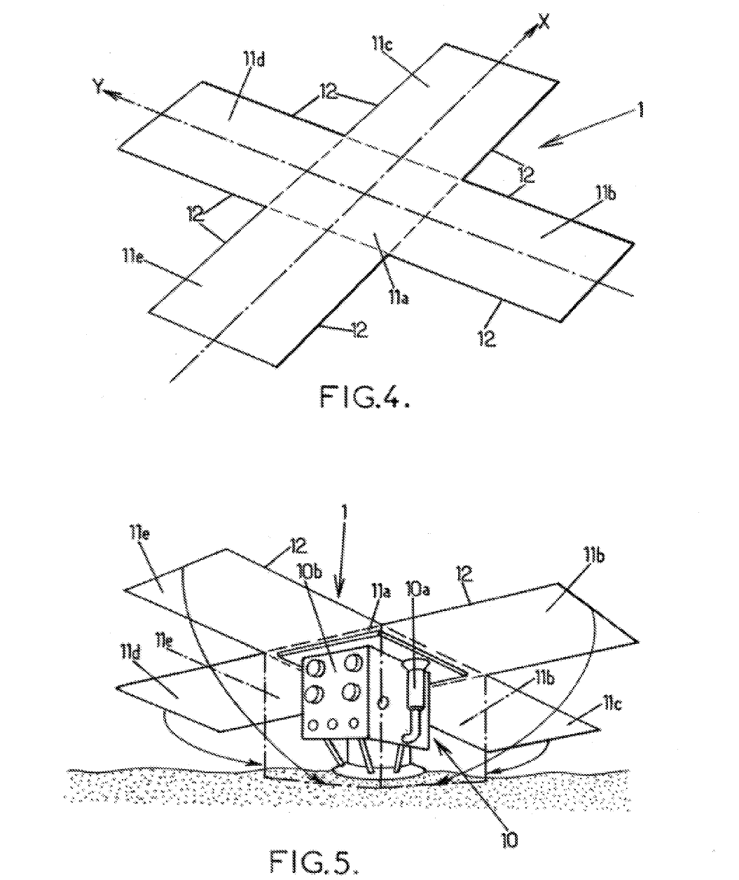

In a second variant form of the surface S of the heating cover 1, shown in FIG. 4, it has a central portion 11a and flap portions 11b, 11c, 11d, 11e located around the central portion 11a.

Such a heating cover 1 can then be used as represented in FIG. 5, which shows a hydrocarbon transportation device 10 called a “Christmas tree” comprising components such as valves and fittings, and a control panel 10a to control said valves or fittings. Such a device can be placed on the seabed as shown.

The heating cover 1 from FIG. 4 can be installed to heat the transportation device 10 in the following manner: The central portion 11a of the heating cover 1 is placed on an upper part of the transportation device 10, the flap portions 10b, 10c, 10d, 10e are each folded vertically as shown by the arrows in FIG. 4 so that each comes over a side part of the transportation device, and each flap portion laterally meets another flap portion by an edge 12 of said flap portion in order to enclose the transportation device 10.

As in the first variant form of the heating cover, the first face F1 is substantially in contact with or in proximity to the transportation device 10, and the second face F2 with the heat insulation layer 5 is oriented towards the outside.

With this second form, the transportation device 10 is enclosed in a substantially fluid-tight volume that is, for example, a parallelepiped. This volume is heated by the heating cover 1 and the disadvantages due to cold mentioned in the introduction are avoided or resolved. The heating cover can subsequently be left or removed for reuse elsewhere or later on.

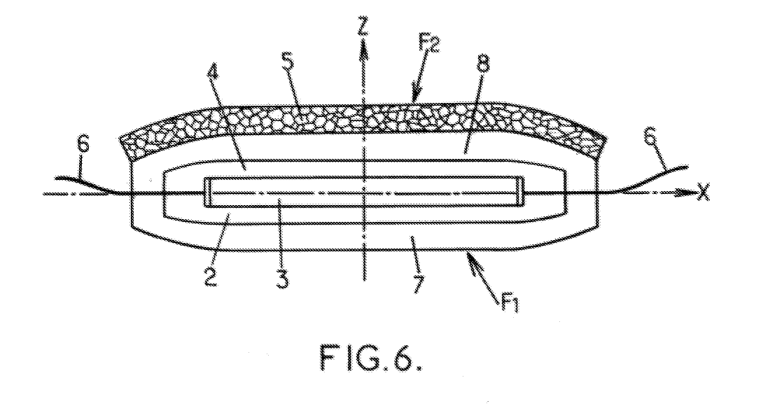

According to a second embodiment of the invention shown in cross-section in FIG. 6, the heating cover 1 comprises in the direction transverse to the surface S, from the first face F1 and in the direction of the second face F2:
a first coating layer 7,
a first electrical insulation layer 2 on the first coating layer 7,
a heating layer 3 on the first electrical insulation layer 2,
a second electrical insulation layer 4 on the heating layer 3,
a second coating layer 8 on the second electrical insulation layer 4, and
a heat insulation layer 5 on the second coating layer 8.

This second embodiment of the heating cover 1 thus comprises two additional coating layers, the first one being located under the first electrical insulation layer 2 (toward the first face F1) and the second between the second electrical insulation layer 4 and heat insulation layer 5.

These coating layers thus substantially cover the electrical insulation layers 2, 4 completely, so that the electrical insulation layers and the heating layer 3 are located inside said coating layers.

With these coating layers, the external fluid-tightness of the cover can be improved.

The coating layers 7, 8 may be composed of the same elastomer as the other layers or of a different elastomer in order to improve fluid-tightness and resistance to the external environment (air or water). The elastomer can be a silicone.

The first and second coating layers 7, 8 have a thickness greater than 0.5 mm, and preferably greater than 2 mm.

The heat insulation layer 5 of this second embodiment can be of the same type as in the first embodiment of the invention. In particular, it can be of polyurethane or comprise a pouch filled with thermally insulating gel.

The electrical power supply means 6 may also be identical to those of the first embodiment of the invention.

Variants of the heating cover 1 may also comprise magnetic elements suitable for the heating cover 1 to be attracted by the transportation device 10 through magnetic attraction, as said device usually comprises magnetic materials such as steel or iron.

These magnetic elements may be discrete or distributed, such as magnetic particles measuring less than 0.2 mm embedded in the elastomer of the layers of the heating cover 1. In an advantageous variant, these magnetic particles are contained in the elastomer of the first electrical insulation layer 2 in the case of the first embodiment, or in the first coating layer 7 in the case of the second embodiment of the invention.

The magnetic particles are composed of a hard magnetic material, for example selected from among ferrite, neodymium iron boron, alnico, and samarium cobalt.

In all cases, these magnetic elements are advantageously placed in proximity to the first face F1, in order to as close as possible to the hydrocarbon transportation device 10 so as to apply sufficient force of magnetic attraction.

Finally, the heating cover according to the invention may be produced by any process, and particularly by a process of elastomer infusion in a mold, wherein one or more layers of fiberglass or Kevlar fibers, superimposed with one or more carbon fiber layers, in turn superimposed with one or more layers of fiberglass or Kevlar fibers, are placed in said mold, then an elastomer is infused or injected into the mold to fill all the interstices among all the fibers and form a common matrix.

Other operations make it possible to establish the connections between the power supply means 6 and the heat insulation layer 5.

Such a heating cover 1 can be manufactured using an inexpensive automated process.

The heating cover 1 produced is flexible and comprises a heating layer made of accident-resistant carbon fibers and able to generate well-distributed and even heat.

The embodiments above are intended to be illustrative and not limiting. Additional embodiments may be within the claims. Although the present invention has been described with reference to particular embodiments, workers skilled in the art will recognize that changes may be made in form and detail without departing from the spirit and scope of the invention.

Various modifications to the invention may be apparent to one of skill in the art upon reading this disclosure. For example, persons of ordinary skill in the relevant art will recognize that the various features described for the different embodiments of the invention can be suitably combined, un-combined, and re-combined with other features, alone, or in different combinations, within the spirit of the invention. Likewise, the various features described above should all be regarded as example embodiments, rather than limitations to the scope or spirit of the invention. Therefore, the above is not contemplated to limit the scope of the present invention.

1. A heating cover for a device for transporting a fluid containing a hydrocarbon, said cover extending over a surface and comprising a first face intended to be substantially in contact with the transportation device and a second face opposite the first face, said heating cover comprising in a direction transverse to the surface, from the first face:
a first electrical insulation layer,
a heating layer on the first electrical insulation layer, said heating layer comprising carbon fibers embedded in an elastomer,
a second electrical insulation layer on the heating layer, said first and second electrical insulation layers covering the heating layer to electrically insulate said heating layer,
a heat insulation layer on the second electrical insulation layer, suitable for thermally insulating the second electrical insulation layer, and
electrical power supply means intended to bring an electrical current to said heating layer, said electrical current flowing in said heating layer in order to heat said heating layer.

2. The heating cover according to claim 1, wherein the heat insulation layer comprises a membrane forming a fluid-tight pouch with an internal cavity in said pouch, said internal cavity being filled with a heat insulation fluid.

3. The heating cover according to claim 2, wherein the heat insulation fluid is a viscous gel.

4. The heating cover according to claim 1, wherein the first and second electrical insulation layers comprise fiberglass or Kevlar fibers embedded in an elastomer.

5. The heating cover according to claim 1, wherein the first and second electrical insulation layers and the heating layer comprise the same elastomer.

6. The heating cover according to claim 1, wherein the elastomer is a silicone.

7. The heating cover according to claim 1, further comprising:
a first coating layer under the electrical insulation layer, and
a second coating layer between the second electrical insulation layer and the heat insulation layer, said first and second coating layers covering said electrical insulations layers in order to be fluid-tight.

8. The heating cover according to claim 7, wherein the first and second coating layers comprise an elastomer, and preferably a silicone.

9. The heating cover according to claim 7, wherein the first and second coating layers have a thickness greater than 0.5 mm, and preferably greater than 2 mm.

10. The heating cover according to claim 1, further comprising a plurality of magnetic elements so as to enable the heating cover to be attracted by the transportation device by magnetic attraction.

11. The heating cover according to claim 10, wherein the magnetic elements are magnetic particles measuring less than 0.2 mm embedded in the elastomer.

12. The heating cover according to claim 10, wherein the magnetic particles are composed of a material selected from among ferrite, neodymium iron boron, alnico, and samarium cobalt.

13. The heating cover according to claim 1, wherein the surface comprises at least:
a central portion intended to come over an upper part of the transportation device (10), and flap portions around the central portion, the flap portions being intended to substantially come over a side part of the transportation device and come together laterally two by two in order to substantially enclose said transportation device.
